(19) United States
(12) Patent Application Publication
(10) Pub. No.: US 2026/0031965 A1
(43) Pub. Date: Jan. 29, 2026

(54) RESOURCE CONTROL FOR WIRELESS TRANSMISSION WITH REPETITION BASED ON SUBBAND FULL DUPLEX

(71) Applicant: ZTE CORPORATION, Shenzhen (CN)

(72) Inventors: Wei GOU, Shenzhen (CN); Xianghui HAN, Shenzhen (CN); Xingguang WEI, Shenzhen (CN); Shuaihua KOU, Shenzhen (CN); Jing SHI, Shenzhen (CN)

(73) Assignee: ZTE CORPORATION, Shenzhen (CN)

(21) Appl. No.: 19/343,988

(22) Filed: Sep. 29, 2025

Related U.S. Application Data
(63) Continuation of application No. PCT/CN2023/087121, filed on Apr. 7, 2023.

(51) Int. Cl. H04L 5/14; H04W 72/0453

(52) U.S. Cl. CPC H04L 5/14; H04W 72/0453

(57) ABSTRACT

This disclosure is generally directed to wireless communication systems and methods, and particularly relates to resource control for wireless transmission with repetitions based on subband full duplex. The various implementations concern determination of conditions under which the various repetitions of an uplink (or downlink) wireless transmission are allowed to be transmitted in a mixed manner across an uplink (or downlink) bandwidth part and an uplink (or downlink) subband within an otherwise downlink (or uplink) bandwidth part. Various mechanisms for determining resources for the transmission of the repetitions based on one or more resource identification fields in a resource control message for scheduling the wireless transmission are further disclosed. Such mechanisms provide consistent resource allocation between the repetitions transmitted in the mixed manner.

### TECHNICAL FIELD

This disclosure is generally directed to wireless communication systems and methods, and particularly relates to resource control for wireless transmission with repetitions based on subband full duplex.

### BACKGROUND

Over-the-air radio resources are critical components in wireless communications networks. Effective communications rely heavily on efficient allocation and controlled usage of these resources. A wireless transmission may be scheduled with repetitions to achieve a redundancy for increasing a success rate of the transmission. The transmission may be downlink or uplink. The repetitions of an uplink (or downlink) transmission may each be allocated with transmission resources belonging to uplink (or downlink) subbands or uplink (or downlink) bandwidth parts (BWPs). An effective control of how these transmission resources are used for transmitting the repetitions is a critical aspect of wireless communication networks.

### SUMMARY

This disclosure is generally directed to wireless communication systems and methods, and particularly relates to resource control for wireless transmission with repetitions based on subband full duplex. The various implementations concern determination of conditions under which the various repetitions of an uplink (or downlink) wireless transmission are allowed to be transmitted in a mixed manner across an uplink (or downlink) bandwidth part and an uplink (or downlink) subband within an otherwise downlink (or uplink) bandwidth part. Various mechanisms for determining resources for the transmission of the repetitions based on one or more resource identification fields in a resource control message for scheduling the wireless transmission are further disclosed. Such mechanisms provide consistent resource allocation between the repetitions transmitted in the mixed manner.

In an example implementation, a method performed by a wireless terminal in communication with a base station is disclosed. The method may include receiving a first configuration from the base station specifying a downlink bandwidth part (BWP) and an uplink BWP for the wireless terminal; receiving a second configuration from the base station specifying an uplink subband; receiving one or more resource control message for an uplink transmission with repetition; determining that an initial repetition and a later repetition of the uplink transmission are allowed to be transmitted across the uplink subband and the uplink BWP or determining that the initial repetition and the later repetition of the uplink transmission are allowed to be transmitted either only in the uplink subband or only in the uplink BWP; and identifying transmission resources for transmitting the initial repetition and the later repetition of the uplink transmission based on the determination.

In another example implementation, a method performed by a wireless network node in communication with a wireless terminal is disclosed. The method may include transmitting to the wireless terminal a first configuration specifying a downlink bandwidth part (BWP) and an uplink BWP for the wireless terminal; transmitting to the wireless terminal a second configuration specifying an uplink subband; and transmitting one or more resource control messages for an uplink transmission to the wireless terminal for the wireless terminal to: determine that an initial repetition and a later repetition of the uplink transmission are allowed to be transmitted across the uplink subband and the uplink BWP or determining that the initial repetition and the later repetition of the uplink transmission are allowed to be transmitted either only in the uplink subband or only in the uplink BWP; and identify transmission resources for transmitting the initial repetition and the later repetition of the uplink transmission based on the determination.

In some other implementations, a wireless communications apparatus is disclosed. The wireless communication apparatus may include a processor and a memory, wherein the processor is configured to read code from the memory and implement any one of the methods above.

In yet some other implementations, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations or UEs and a wireless access network node in communication with one another via an over-the-air radio communication interface.

FIG. 3 illustrates an example uplink subband configuration in relation to uplink bandwidth part and downlink bandwidth part.

### DETAILED DESCRIPTION

The technology and examples of implementations and/or embodiments described in this disclosure can be used to facilitate efficient configuration and allocation of uplink and downlink time-frequency communication resources in wireless networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is generally directed to wireless communication systems and methods and relates particularly to resource configuration and allocation for time-division duplex. The various implementations described in detail below concern scheduling and allocation of time-frequency communication resources within an uplink subband configured within a set of resources that are otherwise configured for downlink transmission or for transmission with a flexible direction. Various embodiments are described below for dynamically scheduling downlink transmissions within the resources of the uplink subband, for modifying/extending resources for the uplink subband in order to improve uplink and downlink transmission resource balance in real-time. The disclosure below further provides various implementations for resolving uplink and downlink transmission time conflict within the uplink subband and for transmitting downlink reference signal over the UL subband.

### Wireless Network Overview

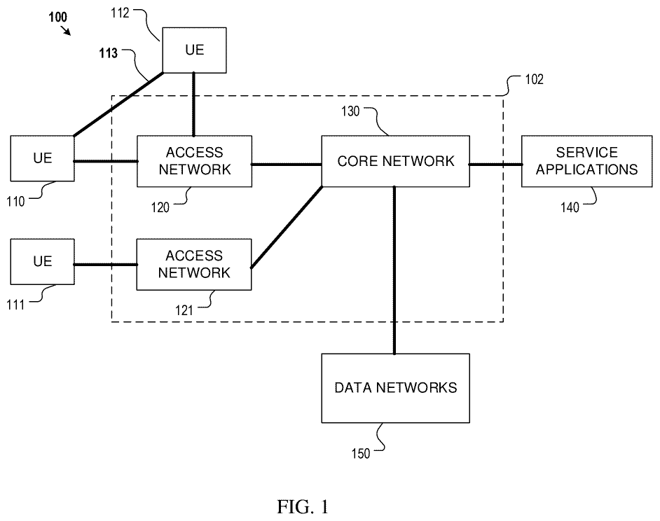

An example wireless communication network, shown as 100 in FIG. 1, may include wireless terminal devices or user equipment (UE) 110, 111, and 112, a carrier network 102, various service applications 140, and other data networks 150. The carrier network 102, for example, may include access networks 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access networks 120 and 121 may be configured as various wireless access network nodes (WANNs, alternatively referred to as base stations) to interact with the UEs on one side of a communication session and the core network 130 on the other. The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the wireless communication network of 100 of FIG. 1, the UEs may communicate with one another via the wireless access network. For example, UE 110 and 112 may be connected to and communicate via the same access network 120. The UEs may communicate with one another via both the access networks and the core network. For example, UE 110 may be connected to the access network 120 whereas UE 111 may be connected to the access network 121, and as such, the UE 110 and UE 111 may communicate to one another via the access network 120 and 121, and the core network 130. The UEs may further communicate with the service applications 140 and the data networks 150 via the core network 130. Further, the UEs may communicate to one another directly via side link communications, as shown by 113.

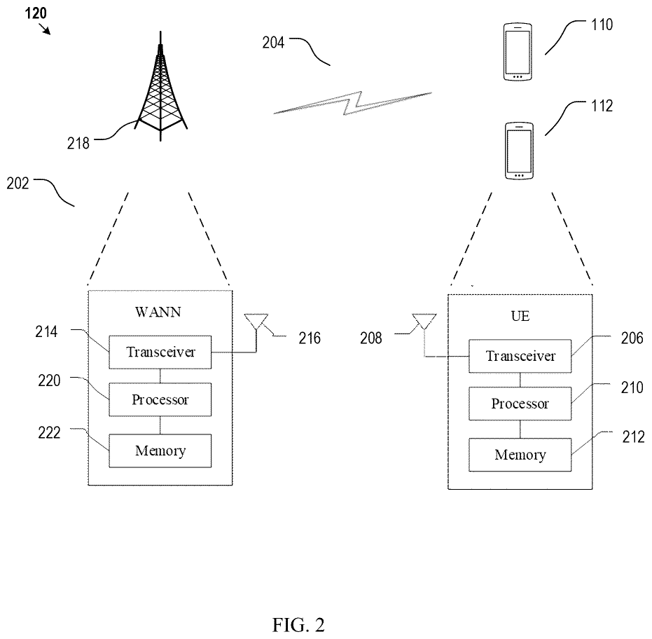

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

### UL/DL Subband and Bandwidth Part

In wireless access communication networks, for a carrier or a frequency band configured for Time Division Duplex (TDD), each time division (e.g., time slot, symbols, or other time units) may be configured either for downlink (DL) or uplink (UL) communications. In addition, a time division may be alternatively configured as a flexible time division which may be used for either DL or UL communication. The term “time division” may represent a time slot, a symbol, or any other time duration that are used as a basic time unit for TDD.

Because DL traffic usually dominates over the UL traffic in wireless access network, DL slots are usually configured more in number than UL slots. An example typical cyclic slot structure may be DDDSU, where D represents a DL time division, U represents a UL time division, and S represents a flexible time division. UL time divisions are usually fewer in number and are often discontinuous, thereby limiting the performance of UL transmission. For example, the UL data volume may be limited, and more importantly, the timeliness and edge coverage of UL transmission may be relatively poor due to frequent UL time division discontinuity.

In some example implementations, the TDD configuration of the time resources for DL communication, UL communication, or flexible communication may be given at slot level. In some other example implementations, the TDD configuration of the time resources for DL communication, UL communication, or flexible communication may be given at symbol (e.g., OFDM symbol) level within a time slot. In other words, a time slot may be configured as a sequence of symbols each being either a UL symbol, a DL symbol, or a flexible symbol.

The resource allocation above in the time domain may be made in any time division, e.g., at time slot level or at symbol level. The various example implementations apply to any time allocation unit. As such, no differentiation is made in the time domain with respect to time slot or symbol and any other allocation time unit.

In some implementations, a UE in communication with a serving cell having a particular carrier frequency with a carrier bandwidth may be allocated with one or more bandwidth parts (BWP) corresponding to a subset of resource blocks in frequency within the carrier bandwidth. A BWP allocated to a UE may be UE specific or may be common to two or more UEs. A BWP may be characterized by a bandwidth, a frequency location (either absolute frequency location or frequency location relative to the carrier band associated with the serving cell), a resource block group (RBG) size, subcarrier spacing (SCS) and the like, all in unit of resource blocks (RBs). The RBG refers to the smallest allocable frequency resources in units of RBs for uplink or downlink transmission/reception. These characteristics may be inter-dependent. One characteristic may be derived from another characteristic via configured or predetermined mapping relationship. For example, the size of the RBG of a BWP, representing a number of RBs in the RBG may depend on the bandwidth of the BWP. In general, for example, an RBG of a larger BWP may be bigger, containing a larger number of RBs. Frequency resources within a BWP that are allocated for uplink/downlink transmission may be represented by RBG indices relative to the BWP for pointing to particular RBGs within the BWP.

A BWP may be allocated for a particular UL, DL, or flexible time division for the UE in the time domain. In some implementations, each of one or more BWPs for the UE may be specifically configured as either a UL BWP or a DL BWP. As such, a UL BWP among the one or more BWPs may be allocated by the base station to a UL time division of the UE, a DL BWP among the one or more BWPs may be allocated to a DL time division of the UE, whereas either a UL or DL BWP among the one or more BWPs may be allocated to a flexible time division of the UE.

In some implementations, the characteristics of a BWP that is allocable to a DL time division may be different from another BWP allocable to a UL time division in, for example, bandwidth, band location, RBG size, and/or SCS. In addition, there may be more than one BWPs that are allocable to a DL time division or a UL time division. These DL BWPs (or UL BWPs) may also differ from one another in bandwidth, band location, RBG size, and/or SCS. In other words, the bandwidth, band location, RBG size, and/or SCS of BWPs allocated to a sequence of time divisions may vary from time division to time division.

As described above, more time divisions may be specified/configured for DL transmission/reception and thus allocated with DL BWP than for UL or flexible transmission/reception because a UE usually perform more DL reception than UL transmission. However, in some example implementations, in order to provide additional UL support to the UE when needed, a subband full-duplex (SBFD) technology may be employed. For example, a subband of frequency resource for uplink may be additional allocated.

In some example implementations, a UL subband for UL transmission may configured within a DL BWP. In other words, a portion of frequency resource, referred to as a UL subband, may be configured to support a UL transmission within DL BWP during one or more consecutive DL and/or flexible time divisions. The other frequency portions of the BWPs within these time divisions remain configured for DL transmission/reception may be referred to as DL frequency portions of such DL BWPs or alternatively referred to as DL subbands. These portions may include parts of the DL BWPs that are used for DL transmission or as frequency gap regions on either sides of the UL subbands. As such, relying on such example UL subbands, a UL transmission can be implemented within time divisions that are otherwise allocated with DL BWPs. UL subband may be configured as UE specific, or at serving cell level and thus may be common for different UEs.

For such example implementations of the UL subband, in a DL time division with a UL subband configured therein, both sides of the UL subband within the corresponding DL BWP in the frequency domain may be used for DL transmission. Because of a close frequency proximity of these DL portions to the UL subband and the DL receptions performed therein, UL transmission performed in the UL subbands may be subject to interference that is more severe than interference for UL transmission using frequency resources of a UL BWP in a UL time division, thereby requiring higher transmission power.

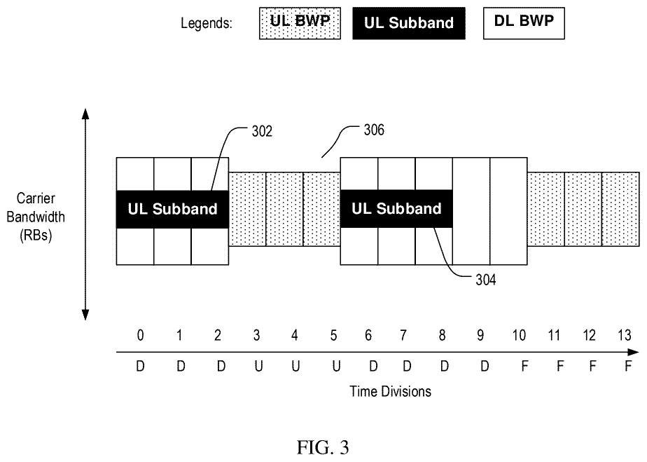

An example configuration of such UL subband implementations is shown in FIG. 3, which illustrates UL BWP and DL BWP encompassing UL subbands across a series of time divisions is illustrated in FIG. 3. The example of FIG. 3 shows the series of time divisions from time division 0 to time division 13 with an example uplink/downlink/flexible time division pattern of DDDUUUDDDDDFFF, and BWPs configured with an example pattern of DDDUUUDDDDDUUU. The configured BWPs are shown as boxes in each time division extending along the frequency axis (the vertical axis) in unit of RBs. In addition, the DL BWPs in time divisions 0-2 and 6-8 are configured with UL subbands shown as 302 and 304. In the example shown in FIG. 3, the DL BWP and UL BWPs differ in size but with their centers aligned. Additionally, in the example of FIG. 3, the UL subband is configured at the center of the DL BWP. With such example configuration, the center of the DL BWP, the UL BWP, and the UL subband would be aligned from one time division to the next time division. In general, however, the size and center location of the UL BWP, the DL BWP, and the UL subband (if configured) may or may not be the same.

In some other example implementations, the UL subband may be configured independent of BWPs. For example, in a DL time division, a configured UL subband may or may not overlap with the DL BWP. When there is overlap, the other portions of the DL BWP may be referred to as DL subband. In such implementations, the UL subband may also be configured in a UL time division, which would constitute additional band for UL transmission if not being within the UL BWP.

While the example configurations above and various example implementations below are described in the context of UL subband configuration in the otherwise DL BWPs to support uplink transmission/reception, the underlying principles apply to counterpart configurations and implementations of DL subbands to support downlink transmission/reception. Those counterpart implementations can be easily derived from the explicitly disclosed example implementations below and are therefore within the coverage scope of this disclosure.

In the disclosure below and from time domain standpoint, the time divisions, symbols or time slots during an SBFD subband (UL subband or DL subband) is configured may be referred to as SBFD divisions, symbols or time slots. Other time divisions, symbols or time slots may be correspondingly referred to as non-SBFD time divisions, symbols or time slots. For example, non-SBFD time divisions, symbols or time slots for uplink may include the UL, DL, and flexible symbols or time slots outside of or not configured with any UL subbands. Likewise, non-SBFD time divisions, symbols or time slots for downlink may include the UL, DL, and flexible time divisions, symbols or time slots outside of any configured DL subbands.

### Wireless Transmission With Repetition

In some implementations, a wireless transmission may be performed with repetition as a redundancy mechanism for improving transmission/reception reliability, or to anticipate potential resource contention for a single transmission. The first transmission of the such repetitions may be referred to as an initial repetition and any one of the repetitions thereafter may be referred to as a later repetition.

For example, a PUSCH transmission with repetition of the UE may be scheduled by the base station via a resource control message (alternatively referred to as resource scheduling message, resource allocation message, e.g., via a downlink control information (DCI) message, or an RRC message, or the like). The resource control message may specify resource-controlling parameters that indicate or control time and frequency resources for performing the repetitions of the PUSCH transmission, including the initial repetition and later repetitions. In some example implementations, these resource controlling parameters may be grouped into single resource indication domain for indicating, controlling, or deriving resources for the transmission of the repetitions. In some example implementation, as shown in further detail below, these parameters may be grouped into two or more resource indication domains, each of the resource indication domains being used to indicate or control resources for the transmission of different repetitions or different sets of repetitions. These resource controlling parameters may directly indicate time and/or frequency locations, sizes, durations of the resources, or indirectly used to derive the time and/or frequency location, size, duration of the resources for the transmission of the repetitions.

For SBFD-aware UEs, resource usage with respect to either non-SBFD symbols in UL BWP or SBFD symbols in UL subband for performing various repetitions of an uplink transmission take the following options:
Option 1: The transmission/reception of the repetitions are restricted to SBFD time divisions (e.g., symbols or slots) only or non-SBFD time divisions only. For example, all repetitions of a UL transmission/reception may be restricted to SBFD time divisions only or non-SBFD time divisions only. Likewise, all DL repetitions of a DL transmission/reception may be restricted to SBFD time divisions only or non-SBFD time divisions only.
Option 2: The transmission/reception of the repetitions are allowed in SBFD time divisions or non-SBFD time divisions, or in other words, are allowed to be transmitted across SBFD time divisions and non-SBFD time divisions (in a mixed manner). For example, some repetitions of a UL (or DL) transmission/reception can be supported in SBFD time divisions, whereas the remaining UL (or DL) repetitions can be supported in non-SBFD time divisions.

The UL repetitions and DL receptions across SBFD time divisions and non-SBFD time divisions may include but are not limited to the following:
PDSCH/PUSCH/PUCCH repetitions;
Semi Persistent Scheduling (SPS) PDSCH/CG PUSCH repetitions;
Transport Block over Multi-Slots (TBoMS) repetitions;
Multi-PUSCH/PDSCH repetitions scheduled by a single DCI;
Periodic/semi-persistent SRS/CSI-RS/PUCCH repetitions;
PDCCH repetitions.

As shown in FIG. 3, the various allocated BWPs at different time divisions (particularly between the DL and UL time divisions) may differ in bandwidth, position, RBG size, SCS, and the like. When performing repetitions of, for example, a UL transmission across SBFD time divisions and non-SBFD time divisions (e.g., an initial repetition in the UL subband 302 and a later repetition in the UL BWP 306), a mechanism for determining the resource blocks to use for each of the repetitions should be designed in order to provide consistent allocation of the resources for transmitting each of the repetitions. The various example implementations below provide mechanisms for determining conditions for allowing repetitions of a transmission/reception to go across the SBFD time divisions and the non-SBFD time divisions (option 2 above), and various manners in which the resources for performing the repetitions are signaled and/or determined/derived/located by the UE and the base station.

The general implementation involved the base station configuring the time divisions into UL, DL or flexible division of the UE, the base station configuring the UE's BWPs (including UL and DL BWPs) in each of the time divisions, the base station configuring the UL or DL subbands, the UE receiving scheduling information for UL or DL transmission with repetition, the UE determining whether the repetitions are allowed to be transmitted/received across the UL/DL subband and the UL/DL BWP, and the UE determining the resources for transmitting/receiving the repetitions in the UL/DL subband and/or UL/DL BWP.

In some example implementations, a SBFD symbol refers to a DL symbol (or a flexible symbol) configured with the UL subband. That is, the UL subband is configured in the DL symbol/slot (or F symbol/slot) as a set of Resource Blocks (RB). The SBFD symbol is in a SBFD slot. That is, a SBFD slot refers to a slot that contains at least one SBFD symbol (Generally, a SBFD slot is also a DL slot). If a PUSCH transmission is scheduled/configured/transmitted in the UL subband or in SBFD symbol(s) or in SBFD slot(s) or in the UL subband in SBFD symbol(s) in SBFD slot(s), then they are equivalent as referring to: the PUSCH transmission is scheduled/configured/transmitted in the UL subband. A non-SBFD symbol refers to a UL symbol (or a flexible symbol) configured with the UL BWP. That is, the UL BWP is configured in UL symbol(s)/slot(s) (or F symbol(s)/slot(s)) as a set of Resource Blocks (RB). A non-SBFD symbol is in a non-SBFD slot. That is, a non-SBFD slot refers to a slot that does not contain any SBFD symbol (Generally, a non-SBFD slot is also a UL slot). If a PUSCH transmission is scheduled/configured/transmitted in the UL BWP or in non-SBFD symbol(s) or in non-SBFD slot(s) or in the UL BWP in non-SBFD symbol(s) in non-SBFD slot(s) or in the UL symbol(s)/slot(s), then it is equivalent as referring to: the PUSCH transmission is scheduled/configured/transmitted in the UL BWP.

### Resource Determination When Repetitions are Allowed to Cross SBFD Time Divisions and Non-SBFD Time Divisions

As an example, assuming that a PUSCH transmission with repetitions is scheduled or configured in a UL subband, or in SBFD time divisions, or in a UL subband in SBFD divisions, then at least the initial repetition of the PUSCH transmission is scheduled or configured in the UL subband in the SBFD symbol in the SBFD time divisions. As described above, an SBFD time division here in the DL context refers to a DL time division or flexible time division configured with the UL subband. An SBFD time division may be an SBFD symbol and may belong to an SBFD time slot. Likewise, if a PUSCH transmission with repetition is scheduled or configured in the UE's UL BWP, or in non-SBFD time divisions, or in the UE's UL BWP in non-SBFD time divisions, then at least the initial repetition of the PUSCH transmission is scheduled or configured in the UE's UL BWP in the non-SBFD time divisions.

In a further example, it may be additionally assumed that the at least one of the remaining PUSCH repetitions is allowed to be transmitted across UE's UL subband within SBFD time divisions or the UE's UL BWP within non-SBFD time divisions (e.g., UL time division) with respect to the initial repetition, then the UE may be configured follow a mechanism to determine consistent resources across the UL subband and the UL BWP for the transmission of the repetitions. For the resources across the UL subband and the UL BWP to be consistent, the resources may be of a same size, location, SCS, and/or the like.

In one particular example of the general implementations above again assuming that the PUSCH transmission with repetitions is scheduled or configured based on DCI or RRC signaling from the base station and the initial PUSCH repetition is scheduled for transmission in the UL subband of SBFD time divisions, and that at least one of the remaining PUSCH repetitions is allowed to be transmitted in the UE's UL BWP within non-SBFD time divisions (e.g., UL time division), then the transmission resources for the initial repetition may be determined based on resource indication fields in an resource indication domain in the DCI or RRC signaling and the UL subband information (or characteristics). The UE may further assume that the allocation of the UL subband and the UL BWP by the base station is such that consistent resources for transmission of the repetitions across the UL subband and the UL BWP can be derived base on the same one or more resource indication fields in the DCL or RRC signaling. As such, for the transmission of at least one later repetition in the UL BWP, the UE may determine/derive transmission resources identification information from the UL BWP of the UE based on the one or more resource indication fields in the resource indication domain of the DCI or RRC signaling and the UL BWP information. Specifically, the resource identification information derivable by the UE from the same one or more resource indication fields in the DCI or RRC signaling and the UL BWP information may include at least one of an RBG size, an SCS, a bandwidth, and a position of the resources for the transmission of the repetition in UL BWP. In some example implementations, such resource identification information for resources for the transmission of the at least one remaining PUSCH repetitions in the UL BWP may be derived as:
An RBG size corresponding to the bandwidth of the UE's UL BWP;
An SCS corresponding to the UL BWP of the UE; and
Bandwidth and position of the UL BWP of the UE.

As such, when mixed SBFD and non-SBFD resources are allowed for transmitting the PUSCH repetitions, the base station may configure the UL subband and the BWP with information/characteristics that, when combined with the resource indication field of DCI or RRC signaling for scheduling the repetition of a PUSCH transmission, yields consistent resources across the UL subband the UL BWP derivable by the UE for transmitting the PUSCH repetition based on the same one or more resource indication fields specified in the DCI or RRC signaling.

For example, assuming that a PUSCH transmission with two repetitions is scheduled or configured by DCI or RRC signaling, and the first PUSCH repetition is transmitted in the UL subband, then based on the one or more resource indication field in the same resource indication domain in the DCI or RRC signaling:
Resource A may be determined by the UE from the UL subband for the initial PUSCH repetition based on resource identification information derived from the one or more resource indication field in the resource indication domain in the DCI or RRC signaling, the resource identification information including at least one of the RBG size corresponding to the bandwidth of the UL subband, the SCS corresponding to the UL subband, and the bandwidth and location corresponding to the UL subband.
Resource B may be determined by the UE from the UL BWP for the second PUSCH repetition based on resource identification information derived from the one or more resource indication field same resource indication domain in the DCI or RRC signaling, the resource identification information including at eat one of the RBG size corresponding to the bandwidth of the UL BWP, the SCS corresponding to the UL BWP, and the bandwidth and location corresponding to the UL BWP.

The BWP and UL subband is configured by the base station such that the resource A in the UL subband and resource B in the UL BWP so derived are consistent.

In some further example implementations of above, power control information associated with the power control indication domain in the DCI or RRC signaling may be determined for the second (or any later) PUSCH repetition based on a set of power control parameters corresponding to the UL BWP or the set of power control parameters corresponding to the UL subband, which may be indicated by the base station via signaling or may be agreed upon between the base station and the UE. For example, the base station and the UE may agree that:
If the initial PUSCH repetition is transmitted in the UL subband, and if a later PUSCH repetition is transmitted in the UL BWP, the information associated with the power control domain for the second PUSCH repetition may be determined based on the set of power control parameters corresponding to the UL subband. Generally, PUSCH transmission requires higher power in the UL subband to overcome interference as described above. In such a manner, the second PUSCH repetition is more likely to obtain higher power.
If the first PUSCH repetition is transmitted on the UL BWP, and if the second PUSCH repetition is transmitted on the UL subband, the information associated with the power control domain for the second PUSCH repetition may also be determined based on the set of power control parameters corresponding to the UL subband.

In some other particular example of the general implementations above, again assuming that the PUSCH transmission with repetitions is scheduled or configured based on DCI or RRC signaling form the base station and the initial PUSCH repetition is scheduled for transmission in the UL subband of the SBFD time divisions, and that at least one of the remaining PUSCH repetitions is allowed to be transmitted in the UE's UL BWP within non-SBFD time divisions (e.g., UL time division). However, the UE may not assume that the base station has allocated the UL subband and the UL BWP such that the characteristics of the allocated UL subband and the BWP in combination with the one or more resource indication fields in the DCI or RRC signaling may not always yield consistent resources for transmitting the repetitions among the UL subband the UL BWP. In that situation, the UE may determine the resources across the UL subband and the UL BWP based on the one or more resource indication fields in the resource indication domain in the DCI or RRC signaling in combination with characteristics of a predetermined one of the UL subband or the UL BWP, so as to ensure that the resources so determined across the UL subband and the UL BWP for transmitting the PUSCH repetitions are consistent.

Specifically, in such implementations, the PUSCH transmission with repetitions may be scheduled or configured based on DCI or RRC signaling. If the initial PUSCH repetition is scheduled/transmitted in the UL subband of the SBFD time divisions, and at least one of the remaining PUSCH repetitions is allowed to be transmitted in the UE's UL BWP within non-SBFD time divisions (e.g., UL time division), then the corresponding resources for the initial repetition may be determined from the UL subband of the UE based on the one or more resource indication fields specified in the resource identification domain in the DCI or RRC signaling in combination with the characteristics of the allocated UL subband. Fo the at least one PUSCH repetition to be transmitted in the UL BWP, the UE may determine the corresponding resources from the UL BWP of the UE based on the same one or more resource indication fields specified in a resource indication domain of the DCI or RRC signaling also in combination with the characteristics of the UL subband rather than the UL BWP. Information associated with or derivable from the one or more resource indication fields in the DCI or RRC signaling may include at least one of an RBG size, an SCS, a bandwidth, and a position. Specifically, the resource identification information derivable by the UE from the same one or more resource indication fields in the DCI or RRC signaling and the UL subband characteristics/information may include at least one of an RBG size, an SCS, a bandwidth, and a position of the resources for the transmission of the repetitions. In some example implementations, such resource identification information for resources for the transmission of the at least one remaining PUSCH repetitions in the UL BWP may be derived as:
An RBG size corresponding to the bandwidth of the UL subband;
An SCS corresponding to the UL subband; and
Bandwidth and position of the UL subband.

As such, when mixed SBFD and non-SBFD resources are allowed for transmitting the PUSCH repetitions, even though the base station may allocate the UL subband and the UL BWP with different characteristics (e.g., different bandwidth, location, and the like), the UE may still be able to determine consistent resources across the UL subband and the UL BWP for transmitting the PUSCH repetitions by forcing the derivation of the resources from either the UL subband or the UL BWP based on the same one or more resource indication fields in a single resource indication domain in the DCI or RRC signaling together with information of the UL subband used for the initial repetition.

For example, suppose that a PUSCH transmission with two repetitions is scheduled or configured for DCI or RRC signaling, the initial PUSCH repetition is transmitted in the UL subband, and a later repetition is transmitted in UL BWP, then based on the one or more resource indication fields of the same resource indication domain in the DCI or RRC signaling:
Resource A may be determined from the UL subband for the initial PUSCH repetition based on resource identification information derived from the resource indication domain in the DCI or RRC signaling, the resource identification information including at least one of the RBG size corresponding to the bandwidth of the UL subband, the SCS corresponding to the UL subband, and the bandwidth and location corresponding to the UL subband.
Resource B is determined from the UL BWP for the second PUSCH repetition based on resource identification information derived from the same resource indication domain in the DCI or RRC signaling, the resource identification information including at eat one of the RBG size corresponding to also the bandwidth of the UL subband, the SCS corresponding to the UL subband, and the bandwidth and location corresponding to the UL subband.

In such implementations, the base station needs not to configure consistent BWP and UL subband for the UE, the consistency of the derived resource A and B across the DL subband and the UL BWP for transmission of the PUSCH repetition nevertheless would be consistent by forcing the derivation to be based on information of UL subband that is used for the initial repetition. Such mechanism may be predetermined and agreed upon between the base station and the UE.

In further implementations of the example above, power control information associated with the power control indication domain in the DCI or RRC signaling may be determined for the second (or any later) PUSCH repetition based on a set of power control parameters corresponding to the UL BWP or the set of power control parameters corresponding to the UL subband, which may be indicated by the base station via signaling or agreed upon between the base station and the UE. For example, the base station and the UE may agree that:
If the initial PUSCH repetition is transmitted in the UL subband, and if a later PUSCH repetition is transmitted in the UL BWP, the information associated with the power control domain for the second PUSCH repetition may be determined based on the set of power control parameters corresponding to the UL subband. Generally, PUSCH transmission requires higher power in the UL subband to overcome interference as described above. In such a manner, the second PUSCH repetition is more likely to obtain higher power.
If the first PUSCH repetition is transmitted on the UL BWP, and if the second PUSCH repetition is transmitted on the UL subband, the information associated with the power control domain for the second PUSCH repetition may also be determined based on the set of power control parameters corresponding to the UL subband.

The above implementations may be applied to the situation where the initial repetition is scheduled for transmission in UL BWP rather than UL subband. Thus, in another particular example of the general implementations above, again assuming that the PUSCH transmission with repetitions is scheduled or configured based on DCI or RRC signaling from the base station but the initial PUSCH repetition is scheduled for transmission in the UL BWP of non-SBFD time divisions (e.g., UL time division), and that at least one of the remaining PUSCH repetitions is allowed to be transmitted in the UE's UL subband within SBFD time divisions, then the transmission resources for the initial repetition may be determined based on resource indication fields in an resource indication domain in the DCI or RRC signaling and the UL BWP information (or characteristics). The UE may further assume that the allocation of the UL subband and the UL BWP by the base station is such that consistent resources for transmission of the repetitions across the UL subband and the UL BWP can be derived base on the same one or more resource indication fields in the DCL or RRC signaling. As such, for the transmission of at least one later repetition in the UL subband, the UE may determine/derive transmission resources identification information from the UL subband of the UE based on the one or more resource indication fields in the resource indication domain of the DCI or RRC signaling and the UL subband information. Specifically, the resource identification information derivable by the UE from the same one or more resource indication fields in the DCI or RRC signaling and the UL subband information may include at least one of an RBG size, an SCS, a bandwidth, and a position of the resources for the transmission of the repetition in UL subband. In some example implementations, such resource identification information for resources for the transmission of the at least one remaining PUSCH repetitions in the UL subband may be derived as:
An RBG size corresponding to the bandwidth of the UL subband;
An SCS corresponding to the UL subband; and
Bandwidth and position of the UL subband.

As such, when mixed SBFD and non-SBFD resources are allowed for transmitting the PUSCH repetitions, the base station may configure the UL subband and the BWP with information/characteristics that, when combined with the resource indication field of DCI or RRC signaling for scheduling the repetition of a PUSCH transmission, yields consistent resources across the UL subband the UL BWP derivable by the UE for transmitting the PUSCH repetition based on the same one or more resource indication fields specified in the DCI or RRC signaling.

For example, assuming that a PUSCH transmission with two repetitions is scheduled or configured by DCI or RRC signaling, and the first PUSCH repetition is transmitted in the UL BWP, then based on the one or more resource indication fields in the same resource indication domain in the DCI or RRC signaling:
Resource A may be determined by the UE from the UL BWP for the initial PUSCH repetition based on resource identification information derived from the one or more resource indication fields resource indication domain in the DCI or RRC signaling, the resource identification information including at least one of the RBG size corresponding to the bandwidth of the UL BWP, the SCS corresponding to the UL BWP, and the bandwidth and location corresponding to the UL BWP.
Resource B may be determined by the UE from the UL subband for the second PUSCH repetition based on resource identification information derived from the one or more resource indication field in same the resource indication domain in the DCI or RRC signaling, the resource identification information including at eat one of the RBG size corresponding to the bandwidth of the UL subband, the SCS corresponding to the UL subband, and the bandwidth and location corresponding to the UL subband.

The BWP and UL subband may be configured by the base station such that the resource A in the UL BWP and resource B in the UL subband so derived are consistent.

In some further example implementations of above, again, power control information associated with the power control indication domain in the DCI or RRC signaling may be determined for the second (or any later) PUSCH repetition based on a set of power control parameters corresponding to the UL BWP or the set of power control parameters corresponding to the UL subband, which may be indicated by the base station via signaling or may be agreed upon between the base station and the UE. For example, the base station and the UE may agree that:
If the initial PUSCH repetition is transmitted in the UL subband, and if a later PUSCH repetition is transmitted in the UL BWP, the information associated with the power control domain for the second PUSCH repetition may be determined based on the set of power control parameters corresponding to the UL subband. Generally, PUSCH transmission requires higher power in the UL subband to overcome interference as described above. In such a manner, the second PUSCH repetition is more likely to obtain higher power.
If the first PUSCH repetition is transmitted on the UL BWP, and if the second PUSCH repetition is transmitted on the UL subband, the information associated with the power control domain for the second PUSCH repetition may also be determined based on the set of power control parameters corresponding to the UL subband.

In some other particular example of the general implementations above, again assuming that the PUSCH transmission with repetitions is scheduled or configured based on DCI or RRC signaling form the base station and the initial PUSCH repetition is scheduled for transmission in the UL BWP of the SBFD time divisions, and that at least one of the remaining PUSCH repetitions is allowed to be transmitted in the UE's UL subband within SBFD time divisions. However, the UE may not assume that the base station has allocated the UL subband and the UL BWP such that the characteristics of the allocated UL subband and the BWP in combination with the one or more resource indication fields in the DCI or RRC signaling may not always yield consistent resources for transmitting the repetitions among the UL subband the UL BWP. In that situation, the UE may determine the resources across the UL subband and the UL BWP based on the one or more resource indication fields in the resource indication domain in the DCI or RRC signaling in combination with characteristics of a predetermined one of the UL subband or the UL BWP, so as to ensure that the resources so determined across the UL subband and the UL BWP for transmitting the PUSCH repetitions are consistent.

Specifically, in such implementations, the PUSCH transmission with repetitions may be scheduled or configured based on DCI or RRC signaling. If the initial PUSCH repetition is scheduled/transmitted in the UL BWP of the non-SBFD time divisions (e.g., UL time division), and at least one of the remaining PUSCH repetitions is allowed to be transmitted in the UE's UL subband within SBFD time divisions, then the corresponding resources for the initial repetition may be determined from the UL BWP of the UE based on the one or more resource indication fields specified in the resource identification domain in the DCI or RRC signaling in combination with the characteristics of the allocated UL BWP. Fo the at least one PUSCH repetition to be transmitted in the UL subband, the UE may determine the corresponding resources from the UL subband of the UE based on the same one or more resource indication fields specified in a resource indication domain of the DCI or RRC signaling also in combination with the characteristics of the UL BWP rather than the UL subband. Information associated with or derivable from the one or more resource indication fields in the DCI or RRC signaling may include at least one of an RBG size, an SCS, a bandwidth, and a position. Specifically, the resource identification information derivable by the UE from the same one or more resource indication fields in the DCI or RRC signaling and the UL BWP characteristics/information may include at least one of an RBG size, an SCS, a bandwidth, and a position of the resources for the transmission of the repetitions. In some example implementations, such resource identification information for resources for the transmission of the at least one remaining PUSCH repetitions in the UL subband may be derived as:
An RBG size corresponding to the bandwidth of the UE's UL BWP;
An SCS corresponding to the UL BWP of the UE; and
Bandwidth and position of the UL BWP of the UE.

As such, when mixed SBFD and non-SBFD resources are allowed for transmitting the PUSCH repetitions, even though the base station may allocate the UL subband and the UL BWP with different characteristics (e.g., different bandwidth, location, and the like), the UE may still be able to determine consistent resources across the UL subband and the UL BWP for transmitting the PUSCH repetitions by forcing the derivation of the resources from either the UL subband or the UL BWP based on the same one or more resource indication fields in a single resource indication domain in the DCI or RRC signaling together with information of the UL BWP used for the initial repetition.

For example, suppose that a PUSCH transmission with two repetitions is scheduled or configured for DCI or RRC signaling, the initial PUSCH repetition is transmitted in the UL BWP, and a later repetition is transmitted in UL subband, then based on the one or more resource indication fields of the same resource indication domain in the DCI or RRC signaling:
Resource A may be determined from the UL BWP for the initial PUSCH repetition based on resource identification information derived from the resource indication domain in the DCI or RRC signaling, the resource identification information including at least one of the RBG size corresponding to the bandwidth of the UL BWP, the SCS corresponding to the UL BWP, and the bandwidth and location corresponding to the UL BWP.
Resource B is determined from the UL subband for the second PUSCH repetition based on resource identification information derived from the same resource indication domain in the DCI or RRC signaling, the resource identification information including at eat one of the RBG size corresponding to also the bandwidth of the UL BWP, the SCS corresponding to the UL BWP, and the bandwidth and location corresponding to the UL BWP.

In such implementations, the base station needs not to configure consistent BWP and UL subband for the UE, the consistency of the derived resource A and B across the DL BWP and the UL subband for transmission of the PUSCH repetition nevertheless would be consistent by forcing the derivation to be based on information of DL BWP that is used for the initial repetition. Such mechanism may be predetermined and agreed upon between the base station and the UE.

In further implementations of the example above, power control information associated with the power control indication domain in the DCI or RRC signaling may be determined for the second (or any later) PUSCH repetition based on a set of power control parameters corresponding to the UL BWP or the set of power control parameters corresponding to the UL subband, which may be indicated by the base station via signaling or agreed upon between the base station and the UE. For example, the base station and the UE may agree that:
If the initial PUSCH repetition is transmitted in the UL subband, and if a later PUSCH repetition is transmitted in the UL BWP, the information associated with the power control domain for the second PUSCH repetition may be determined based on the set of power control parameters corresponding to the UL subband. Generally, PUSCH transmission requires higher power in the UL subband to overcome interference as described above. In such a manner, the second PUSCH repetition is more likely to obtain higher power.
If the first PUSCH repetition is transmitted on the UL BWP, and if the second PUSCH repetition is transmitted on the UL subband, the information associated with the power control domain for the second PUSCH repetition may also be determined based on the set of power control parameters corresponding to the UL subband.

### Determining Whether Repetitions are Allowed to Cross SBFD Time Divisions and Non-SBFD Time Divisions by UL Subband and UL BWP Characteristics

Assume that the UL subband is configured and that a UL BWP is configured for the UE, and a PUSCH transmission with repetitions is scheduled or configured for UE via DCI or RRC signaling. Determination by the UE as to whether to allow performing the repetitions of the PUSCH transmission across the UL subband and the UL BWP at different time divisions may be made in the following example manners.

For example, the UE may derive a first RBG size and/or a first SCS corresponding to the PUSCH resource allocation in the UL BWP and derive a second RBG size and/or a second SCS corresponding to the PUSCH resource allocation in the UL subband. The UE may compare the first RBG size and/or the first SCS with the second RBG size and/or the second SCS to determine if they are the same. If they are the same, then different repetitions of the PUSCH transmission can be allowed to be transmitted across the UL subband (in the SBFD time division(s)) and in the UL BWP (in the UL time division(s)).

For another example, in addition to or alternative to comparing the first the RBG size and the second RBG size, and/or comparing the first SCS and the second SCS to determine if they are the same, the UE may further compare a first bandwidth and location of the UL subband and a second bandwidth and location of the UL BWP to determine if they are also the same. If they are the same, then the UE may determine that different repetitions of the PUSCH transmission can be allowed to be transmitted across the UL subband (in the SBFD time division(s)) and in the UL BWP (in the UL time division(s)).

For example, if a PUSCH transmission with two repetitions is scheduled or configured via DCI or RRC, and the RBG size and SCS meet the above conditions, and the SBFD time divisions and non-SBFD divisions are configured to appear alternately, then one of the two repetitions of the PUSCH transmission may be transmitted in the UL subband and the other repetition may be transmitted in the UE's UL BWP according to the SBFD time division configuration pattern. That is, one of the two repetitions of the PUSCH transmission may be transmitted in SBFD time divisions and the other repetition is transmitted in non-SBFD time divisions according to the SBFD time division configuration pattern.

Correspondingly, assuming that the UL subband is configured and a UL BWP is configured for the UE, and a PUSCH transmission with repetitions is scheduled or configured for UE via DCI or RRC signaling. If the RBG size and/or SCS corresponding to the PUSCH resource allocation in the UL BWP and the RBG size and/or SCS corresponding to the PUSCH resource allocation in the UL subband are different (in addition or alternatively that the bandwidth and location of the UL subband and the UL BWP are also different for the PUSCH resource allocation), then the repetitions may not be allowed to cross the UL BWP and the UL subband, and all later repetitions of the PUSCH transmission are transmitted in the UL subband only or in the UL BWP only, following the transmission of the initial repetition. If the initial repetition is transmitted in the UL subband, the remaining repetitions are also transmitted in the UL subband. If the first repetition is transmitted in the UL BWP, the remaining repetitions are also transmitted in the UL BWP.

For a particular example, if a PUSCH transmission with two repetitions is scheduled or configured for UE via DCI or RRC signaling, and the RBG size and SCS do not meet the above conditions, and the SBFD time divisions and non-SBFD time divisions are configured to alternate, then the two repetitions of the PUSCH transmission are transmitted in the UL subband if the first repetition is transmitted in the UL subband. Likewise, the two repetitions of the PUSCH transmission are transmitted in the UL BWP if the first repetition is transmitted in the UL BWP. In other words, the two repetitions of the PUSCH transmission are transmitted in SBFD time divisions if the first repetition is transmitted in SBFD time divisions, or the two repetitions of the PUSCH transmission are transmitted in non-SBFD time divisions if the first repetition is transmitted in non-SBFD time divisions.

In the manner above, the same resources (RB size, SCS, and/or location) can be obtained for the repetitions transmitted in the UL subband and the repetitions transmitted in the UL BWP based on the same resource indication domain in the DCI or RRC signaling.

In some other example implementations, again assume that the UL subband is configured and that a UL BWP is configured for the UE, and a PUSCH transmission with repetitions is scheduled or configured for UE via DCI or RRC signaling. If the same and/or valid resources can be obtained for different repetitions in the UL subband and the UL BWP based on the resource indication domain in the DCI or RRC signaling, then the different repetitions are allowed transmitted in the UL subband (in SBFD time divisions) and in the UL BWP (in UL time divisions); Otherwise, different repetitions are not allowed to transmit across the UL BWP and the UL BWP and are transmitted in the UL subband only or in the UL BWP only. In other words, if the above conditions are satisfied, then the different repetitions can be transmitted across SBFD time divisions and non-SBFD divisions; Otherwise, different repetitions are allowed to be transmitted in SBFD time divisions only or in non-SBFD time divisions only.

In the example implementations above, the term “same resources” may mean that the sizes of the resources are the same in RB, while the time domain symbol/slot indices and/or frequency domain locations of the two resources can be different (may or may not be the same). Alternatively, the term “same resource” may means that both the sizes and frequency domain locations of two resources are the same, while the time domain symbol/slot indices of the two resources may or may be the same. Alternatively, the term “same resources” may mean that the sizes, the time domain symbol/slot indices, and the frequency domain locations of the two resources are all the same.

Further in the example implementation above, the term “valid resource” with respect to UL subband refers to a resource that falls within SBFD time division in the time domain and the UL subband in the frequency domain. Likewise, the term “valid resource” with respect to UL BWP refers to a resource falls within the non-SBFD time division in the time domain and the UL BWP in the frequency domain.

In the manner described above, if two PUSCH resource sets are configured for the UL subband and the UL BWP, then based on the same resource indication domain in the DCI or RRC signaling, two resources can be determined for transmitting the repetitions in the UL subband and the repetitions in the UL BWP, respectively if the resources are the same and/or valid.

### Determining Whether Repetitions are Allowed to Cross SBFD Time Divisions and Non-SBFD Time Divisions by Direct Signaling

In some example implementations, a new RRC signaling or a new resource indication field in the DCI may be introduced for signaling whether repetitions of a transmission/reception are allowed to cross the SBFD time divisions (UL subband) and non-SBFD time divisions (UL BWP).

For example, the new RRC signaling or the new resource indication field may be used to indicate two states: the first state indicating that different repetitions of a PUSCH transmission are transmitted in the UL subband only or in the UL BWP only; and the second state indicating that the different repetitions can be transmitted across the UL subband and the UL BWP.

Alternatively, the new RRC signaling or the new resource indication field may be used to indicate two states: the first state indicating that different repetitions of a PUSCH transmission with repetitions can be transmitted in the UL subband and in the UL BWP; the second state indicating that the different repetitions are transmitted in the UL subband only or in the UL BWP only based on whether UL subband or UL BWP resources are used for the first repetition.

Alternatively, new RRC signaling or the new resource indication field may be used to indicate three states: the first state indicating that different repetitions of a PUSCH transmission are transmitted in the UL subband only; the second state indicating that the different repetitions are transmitted in the UL BWP only; the third state indicating that the different repetitions can be transmitted across the UL subband and the UL BWP.

In some other example implementations, the presence or absence of the new RRC signaling or the new resource indication filed in DCI may be considered as representing a state of indication.

For example, the new RRC signaling or the new resource indication field in DCI, when in presence, may be configured with at least two states (each state corresponds to a processing method), and is used to indicate that different repetitions of a PUSCH transmission with repetitions are transmitted in the UL subband only, or are transmitted in the UL BWP only. If the new RRC signaling or the new resource indication field in DCI is not configured (absence), then it may be considered as an indication that different repetitions can be transmitted across the UL subband and the UL BWP.

Alternatively, the new RRC signaling or the new resource indication filed in DCI, when in presence, may be configured with at least two states (each corresponding to a processing method) to indicate that different repetitions of a PUSCH transmission with repetitions are transmitted in the UL subband only, or can be transmitted cross the UL subband and in the UL BWP. If the new RRC signaling or the new resource indication field in DCI is not configured (absence), it may be considered as an indication that the different repetitions are transmitted in the UL BWP only.

Alternatively, the presence of the new RRC signaling or the new resource indication filed in DCI may be used as a single state (for example, once configured, the parameter value is a predefined value) to indicate that different repetitions of a PUSCH transmission with repetitions are transmitted in the UL subband only or in the UL BWP only based on whether UL subband or UL BWP resources are used for the first repetition. If the new RRC signaling or the new resource indication field in DCI is not configured (absence), it may be considered as an indication that the different repetitions can be transmitted across the UL subband and the UL BWP.

In some example implementations, based on the above new RRC signaling or new resource indication filed in DCI, the base station and UE operate based on the following agreed-upon rules: if different repetitions of a PUSCH transmission are determined to be transmitted across the UL subband and in the UL BWP based on the new RRC signaling or new resource indication domain or filed in DCI as described above, then at least one of the following parameters should be made the same for the PUSCH transmission in the UL subband and in the UL BWP: RBG size, SCS, bandwidth, and frequency domain location. The same parameters may be determined in the following manners:
The RBG size of the UL subband may be forced to be equal to the RBG size of the UL BWP (or the RBG size of the UL subband is determined based on the bandwidth of the UL BWP), so that the RBG size of the UL subband so determined is the same as the UL BWP;
The RBG size of the UL BWP may be forced to be equal to the RBG size of the UL subband (or the RBG size of the UL BWP is determined based on the bandwidth of the UL subband), so that the RBG size of the BWP subband so determined is the same as the UL subband;
The RBG size of the UL BWP and the RBG size of the UL subband are determined based on the resource type of the first repetition. For example, if the first repetition is transmitted in the UL subband, then the RBG size of both the UL BWP and the UL subband is forced to be equal to the RBG size of the UL subband (as determined from the bandwidth of the UL subband) for the PUSCH transmission. Likewise, if the first repetition is transmitted in the UL BWP, the RBG size of both the UL BWP and the UL subband is forced to be equal to the RBG size of the UL BWP (as determined from the bandwidth of the UL BWP) for the PUSCH transmission;
The SCS of the UL subband is forced to be equal to the SCS of the UL BWP, so that the SCS of the UL subband and the UL BWP are the same;
The SCS of the UL BWP is forced to be equal to the SCS of the UL subband, so that the SCS of the UL subband and the UL BWP are the same;
The SCS of the UL BWP and the SCS of the UL subband are determined based on the resource type of the first repetition. For example, if the first repetition is transmitted in the UL subband, then the SCS of both the UL BWP and the UL subband is forced to be equal to the SCS of the UL subband for the PUSCH transmission. Likewise, if the first repetition is transmitted in the UL BWP, the SCS of both the UL BWP and the UL subband is forced to be equal to the SCS of the UL BWP for the PUSCH transmission.

In such a manner, if the RBG size or SCS determined for the UL subband and the UL BWP are different based on their respective bandwidth or configuration, and if the new RRC signaling or the indication domain A indicates that different repetitions of a PUSCH transmission with repetitions can be transmitted in the UL subband and in the UL BWP, then the UE considers that the same RBG size or SCS should be used based on the above method for the different repetitions of the PUSCH transmission in the UL subband and in the UL BWP.

### Signaling Whether Repetitions are Allowed to Cross SBFD Time Divisions and Non-SBFD Time Divisions Using Resource Indication Domains

In some example implementations, an additional resource allocation domain (marked as FDRA2, representing a second Frequency Domain Resource Allocation, to differentiate the original resource allocation domain marked FDRA1) may be introduced in DCI or RRC signaling. For example, the new FDRA domain may be used for resource allocation within the UL subband. The UE may determine a resource for a PUSCH transmission from the UL subband according to the resource indication fields of FDRA2. If PUSCH resource sets are configured for the UL subband and the UL BWP, then the FDRA1 can be used to determine PUSCH resources from the UL BWP, and the FDRA2 can used to determine PUSCH resource from the UL subband.

For example, a PUSCH transmission with repetitions may be scheduled or configured for UE via DCI or RRC signaling. The base station and UE may agree to determine based on the above FDRA values and the following rules that different repetitions of the PUSCH transmission are transmitted in the UL subband of the SBFD time divisions only or in the UL BWP of the non-SBFD time divisions only, or that the different repetitions can be transmitted across the UL subband of the SBFD time divisions and in the UL BWP of the non-SBFD time divisions.

Specifically, assuming that FDRA1 corresponds to the UL BWP in the non-SBFD time divisions and FDRA2 corresponds to the UL subband in the SBFD time divisions. A PUSCH transmission with repetitions may be scheduled or configured for UE via DCI or RRC signaling. If two valid resources are determined in the UL BWP in the non-SBFD time divisions and in the UL subband in the SBFD time divisions respectively according to the FDRA1 value and FDRA2 value in the DCI or RRC signaling, then different repetitions of the PUSCH transmission can be transmitted in the UL subband and the UL BWP in the two valid resources according to the SBFD time division configuration pattern. For example, if the SBFD time division and the non-SBFD time division alternate based on the SBFD slot pattern, then the two repetitions of the PUSCH transmission are respectively transmitted in the resource corresponding to FDRA1 in the UL BWP in the non-SBFD time division and in the resource corresponding to FDRA2 in the UL subband in the SBFD time division.

Alternatively, assume that a PUSCH transmission with repetitions is scheduled or configured for UE via DCI or RRC signaling. If two resources are determined to be in the UL BWP in the non-SBFD time divisions or in the UL subband in the SBFD time divisions based on the FDRA1 value and FDRA2 value in the DCI or RRC signaling, but only one of the two resources is valid, then different repetitions of the PUSCH transmission are transmitted only in the UL subband or in the UL BWP corresponding to the one valid resource according to the SBFD time division configuration pattern. For example, if the one valid resource is the resource corresponding to the FDRA1 value, then the different repetitions are transmitted in the UL BWP in the non-SBFD time division only. If the one valid resource is the resource corresponding to the FDRA2 value, the different repetitions are transmitted in the UL subband in the SBFD time division only.

In some example implementations, a PUSCH transmission with repetitions may be scheduled or configured for UE via DCI or RRC signaling. If the FDRA1 value and FDRA2 value in the DCI or RRC signaling are invalid, the repetitions of the PUSCH transmission are not transmitted in the UL BWP or the UL subband corresponding to the invalid FDRA1 value or invalid FDRA2 value. Examples include:
For example, for type 0 PUSCH resource allocation, if the value of FDRA1 is set to all 0 (all 0 is an invalid value for type 0 PUSCH resource allocation), and the value of FDRA2 is set to a value other than all 0, then the different repetitions of the PUSCH transmission are transmitted in the UL subband in the SBFD time division only based on the SBFD time division configuration pattern.
For another example, for type 0 PUSCH resource allocation, if the value of FDRA2 is set to all 0 (all 0 is an invalid value for type 0 PUSCH resource allocation), and the value of FDRA1 is set to a value other than all 0, then the different repetitions of the PUSCH transmission are transmitted in the UL BWP in the non-SBFD time division only based on the SBFD time division configuration pattern.
For another example, for type 1 PUSCH resource allocation, if the value of FDRA1 is set to all 1 (all 1 is an invalid value for type 1 PUSCH resource allocation), and the value of FDRA2 is set to a value other than all 1, then the different repetitions of the PUSCH transmission are transmitted in the UL subband in the SBFD time division only based on the SBFD time division configuration pattern.
For another example, for type 1 PUSCH resource allocation, if the value of FDRA2 is set to all 1 (all 1 is an invalid value for type 1 PUSCH resource allocation), and the value of FDRA1 is set to a value other than all 1, then the different repetitions of the PUSCH transmission are transmitted in the UL BWP in the non-SBFD time division only based on the SBFD time division configuration pattern.

The FDRA1 domain and FDRA2 domain above can be configured to be present or be absent. Such presence or absence may be considered in determining the resource configuration for the repetitions. For example, if only one FDRA domain exists in the DCI based on the RRC signaling configuration, then different repetitions of the PUSCH transmission are transmitted only in the UL subband or the UL BWP corresponding to the FDRA domain that is present. Specifically, if the FDRA1 domain is present and the FDRA2 domain is absent, then different repetitions of the PUSCH transmission are transmitted in the UL BWP only. Likewise, if the FDRA1 domain is present and the FDRA2 domain is absent, then different repetitions of the PUSCH transmission are transmitted in the UL BWP only.

The above valid resource refers to a resource that is only within the time and frequency domain of the UL subband, or a resource that is only within the frequency domain of the UL BWP and does not overlap DL time division. The DL time division (symbol or slot) is defined according to the definition of the TDD frame structure.

### RRC Signaling Enhancement for Base Station Management

In some example implementations, a first RRC signaling message or information element may be introduced. The first RRC signaling may indicate to the UE that it is possible that different repetitions of the PUSCH transmissions with repetitions can be transmitted across the UL subband and the UL BWP. If the first RRC signaling is configured for the UE, the UE may consider that it is allowed to evaluate whether different repetitions can be transmitted across the UL subband and the UL BWP. The UE may further determine that different repetitions are transmitted in the UL subband only or in the UL BWP only, or that different repetitions can be transmitted in the UL subband and the UL BWP according to the conditions and rules about the resources across the UL subband and the UL BWP as described in the various example implementations above. However, if the first RRC signaling is not configured for the UE, the UE may consider that the different repetitions are transmitted in the UL subband only or in the UL BWP only based on resource type (UL subband or the UL BWP) of the first repetition.

In some other example implementations, a second RRC signaling message or information element may be introduced. The second RRC signaling may indicate to the UE that that different repetitions of the PUSCH transmissions with repetitions cannot be transmitted in the UL subband and the UL BWP. As such, if the second RRC signaling is configured for the UE, the UE considers that the different repetitions are transmitted in the UL subband only or in the UL BWP only based on the resource type (the UL subband or the UL BWP) for the first repetition. However, if the second RRC signaling is not configured for the UE, the UE considers that different repetitions can be transmitted across the UL subband and the UL BWP. Under that condition, the UE may further determine that different repetitions are transmitted in the UL subband only or in the UL BWP only, or that different repetitions can be transmitted in the UL subband and the UL BWP according to the conditions and rules described in the various example implementations above.

In such manners, the first or the second RRC signaling are beneficial for enhancing the management of the base station.

In some other example implementations, a third RRC signaling message or information element may be introduced. The third RRC signaling may indicate to the UE that different repetitions of the PUSCH transmissions with repetitions can be transmitted in the UL subband and the UL BWP, or that the different repetitions are transmitted in the UL subband only or in the UL BWP only based on resource type (the UL subband or the UL BWP) for the first repetition. The UE can determine the corresponding transmission method according to the indication of the third RRC signaling 3.

The first, second, and the third RRC signaling above may be used independently for PUSCH transmission with repetitions, without considering the RBG size and SCS of the UL subband and the UL BWP.

In such manners, the first, the second, and the third RRC signaling are beneficially introduced and used for enhancing the management of the base station.

### Modified Bandwidth for Determining RBG Size

In some other example implementations, considering that when a PUSCH transmission of a UE is transmitted in the UL subband, the resources for the PUSCH transmission are required to be within the UL subband. It may be additionally required that such resources are also within the UL BWP of the UE. In other words, it may be required that the resource used for the PUSCH transmission is within an intersection of the UL subband and the UL BWP in the frequency domain. Under such allocation and research usage scheme, when determining resources to use for the PUSCH repetitions, for example, in the UL subband, the RBG size to be utilized with the resource allocation domain (e.g., in DCI) may be determined based on:
Option 1: The size of the bandwidth corresponding to the intersection resource of the UL subband and the UE's UL BWP in the frequency domain.
Option 2: The size of the bandwidth obtained based on the following equation: minimum of the size of the bandwidth of the UL subband and the size of the bandwidth of the UL BWP of the UE.

The UL subband above may be either a common UL subband allocated to multiple UEs or a UE specific UL subband, as described above.

In some example implementations, the above method may exclude frequency domain resources that are not possible for PUSCH transmission when determining the RBG size.

### Time Division Resource Determination

In the above methods 1-7, a PUSCH transmission with repetitions may be scheduled or configured for UE via DCI or RRC signaling. The first repetition of the PUSCH transmission may be transmitted in the time division(s) as indicated in the DCI or RRC signaling in the time domain. The time division as indicated by the DCI or RRC signaling may be one or more SBFD time divisions (or time divisions configured with the UL subband in the frequency domain) or one or more non-SBFD time divisions (or time divisions not configured with the UL subband in the frequency domain). In this case, subsequent time divisions for transmitting the remaining repetitions of the PUSCH transmission may be determined based on one of the following rules (assuming that one repetition is transmitted in one time division, so the repetitions correspond time divisions in a one-to-one manner):
Rule 1: If different repetitions of the PUSCH transmission can be transmitted across the UL subband and the UL BWP, then if a time division contains a symbol with the UL subband (an SBFD symbol), and starting from this symbol, a number of consecutive symbols with the UL subband (or a number of consecutive SBFD symbols) is not fewer than a number of symbols configured for the first repetition, then the time division with the UL subband is considered as the subsequent time division for transmitting a repetition. Likewise, if different repetitions of the PUSCH transmission can be transmitted in the UL subband and in the UL BWP, if a time division contains a UL symbol (or a non-SBFD symbol) and starting from the this symbol, a number of consecutive UL symbols (or a number of consecutive non-SBFD symbols) is not fewer than a number of symbols configured for the first repetition, then the time division with the UL symbol may be considered as the subsequent time division for transmitting a repetition.
Rule 2: If different repetitions of the PUSCH transmission are transmitted in the UL subband only or in the UL BWP only, and the first repetition is transmitted in the UL subband in a time division indicated by the DCI or the RRC signaling, then if another time division contains a symbol with an UL subband (or an SBFD symbol) and starting from the that symbol, a number of consecutive symbols with the UL subband (or a number of consecutive SBFD symbols) is not fewer than a number of symbols configured for the first repetition, that second time division configured with the UL subband may be considered as a subsequent time division for transmitting a repetition.
Rule 3: If different repetitions of the PUSCH transmission are transmitted only in the UL subband or in the UL BWP, and the first repetition is transmitted in the UL BWP in a time division indicated by the DCI or the RRC signaling, then if a second time division contains a UL symbol (or a non SBFD symbol), and starting from that symbol, a number of consecutive UL symbols (or consecutive non SBFD symbols) is not less than a number of symbols configured for the first repetition, the second time division may be considered as a subsequent time division for transmitting a repetition.

Such subsequent time divisions may be counted as time divisions attributable to the PUSCH transmission. If the PUSCH transmission is configured with n repetitions, a total of n time divisions may be determined/identified for the PUSCH transmission according to the rules above. As such, in addition to the first time division for transmitting the first repetition being indicated by the DCI or RRC signaling, subsequent n−1 time divisions may be determined based on the rules above (e.g., rule 1). In some implementations, even if the PUSCH transmission is not actually transmitted in a subsequent time division for some reasons (e.g., when other conflict occurs), the PUSCH transmission is still counted as being transmitted once in that subsequent time division. The number of actual repetitions of the PUSCH transmission may be reduced 1 in that situation. The reasons that a repetition may not be transmitted in a subsequent time division may include but are not limited to: the PUSCH transmission is canceled in the subsequent time division due to the overlapping of the PUSCH transmission with other transmissions (such as higher priority transmissions from the UE itself or other UEs) in the subsequent time division in the time domain.

### Applying Methods Above to Transmission/Receptions Other Than PUSCH Repetitions

The various example implementations for repetitions of PUSCH transmission/receptions may be applied to other types of transmissions with repetition.

For example, the example implementations above may be applied to PDSCH transmissions with repetitions by replacing the term “PUSCH” with “PDSCH”, the term “PUSCH repetition” with “PDSCH repetition”, and replacing the term “UL subband” with “DL subband”, and replacing the “UL BWP” with “DL BWP”. For example, if a PDSCH transmission with repetitions is scheduled or configured for UE via DCI or RRC signaling, then different repetitions of the PDSCH transmission may be transmitted in the DL subband only or in the DL BWP only, or the different PDSCH repetitions can be transmitted across the DL subband and the DL BWP. All aspects of the implementations related to PUSCH applies.

The various implementations above for transmission repetitions may further be applied to multi-block PUSCH transmission. For example, in the situation where a large transmission block is scheduled, where the large transmission block is divided into multiple small blocks, and where the multiple small blocks are respectively transmitted in multiple different PUSCH transmissions, the example implementations above for transmission of PUSCH repetitions may be applied. Each small PUSCH block may correspond to a “PUSCH repetition” above. For example, a large transmission block may be scheduled by a DCI, and the large transmission block may be divided into multiple small blocks. The multiple small blocks may be transmitted as multiple different PUSCH transmissions. Then the different PUSCH transmissions, just like the PUSCH repetitions above, can be transmitted in the UL subband only or in the UL BWP only, or may be transmitted across the UL subband and the UL BWP. All aspects of the implementations related to PUSCH applies.

In some implementations, the various implementations above for PUSCH transmission repetitions may further be applied to multiple PUSCH transmission scheduled by one or more DCIs by replacing the term “PUSCH repetition” above with “one transmission of the multiple PUSCH transmissions.” As such, each one of the multiple PUSCH transmissions is treated as a PUSCH repetition. For example, if a DCI schedules multiple different PUSCH transmissions, the different PUSCH transmissions may be transmitted in the UL subband only or in the UL BWP only, or may be transmitted across the UL subband and the UL BWP. All aspects of the implementations related to PUSCH applies.

Likewise, the various implementations above for PUSCH transmission repetitions may further be applied to multiple PDSCH transmission by replacing the “PUSCH” above with “PDSCH”, and replacing the “PUSCH repetition” above with “one transmission of the multiple PDSCH transmissions”, and replacing the “UL subband” above with “DL subband”, and replacing the “UL BWP” above with “DL BWP”. For example, if a DCI schedules multiple different PDSCH transmissions, the different PDSCH transmissions may be transmitted in the DL subband only or in the DL BWP only, or may be transmitted across the DL subband and the DL BWP. All aspects of the implementations related to PUSCH applies.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method, performed by a wireless terminal in communication with a base station, comprising:
receiving one or more resource control messages for an uplink transmission with repetition;
determining that an initial repetition and a later repetition of the uplink transmission are allowed to be transmitted in subband full duplex (SBFD) symbols and non-SBFD symbols or that the initial repetition and the later repetition of the uplink transmission are allowed to be transmitted either only in SBFD symbols or only in non-SBFD symbols; and
identifying transmission resources for transmitting the initial repetition and the later repetition of the uplink transmission based on the determination.

2. The method of claim 1, wherein:
the one or more resource control messages comprise one or more resource identification fields; and
identifying the transmission resources is based on the determination and the one or more resource identification fields.

3. The method of claim 1, wherein the method further comprises:
in response to determining that the initial repetition and the later repetition are transmitted either only in the SBFD symbols or only in the non-SBFD symbols, identifying the transmission resources for transmitting the initial repetition and the later repetition comprises identifying a first transmission resource for the initial repetition and the later repetition in the SBFD symbols or identifying a second transmission resource for the initial repetition and the later repetition in the non-SBFD symbols.

4. The method of claim 2, further comprising:
receiving a first configuration from the base station specifying a downlink bandwidth part (BWP) and an uplink BWP for the wireless terminal; and
receiving a second configuration from the base station specifying an uplink subband,
wherein a symbol is an SBFD symbol when the symbol includes an SBFD subband, and is a non-SBFD symbol otherwise.

5. The method of claim 4, wherein in response to determining that the initial repetition and the later repetition are allowed to be transmitted in the SBFD symbols and the non-SBFD symbols, identifying the transmission resources for transmitting the initial repetition and the later repetition comprises identifying a first transmission resource for the initial repetition and identifying a second transmission resource for the later repetition from either the uplink subband or the uplink BWP.

6. The method of claim 5, wherein:
the first transmission resource is determined based on the one or more resource identification fields in combination with a first resource information derived from characteristics of one of the uplink subband in SBFD symbols or the uplink BWP in non-SBFD symbols whichever is used for transmitting the initial repetition; and the second transmission resource is determined based on the same one or more resource identification fields in combination with a second resource information derived from characteristics of the other one of the uplink subband in SBFD symbols or the uplink BWP in non-SBFD symbols whichever is used for transmitting the later repetition; or
both the first transmission resource and the second transmission resource are determined based on the one or more resource identification fields in combination with resource information derived from characteristics of one of the uplink subband in SBFD symbols or the uplink BWP in non-SBFD symbols whichever is used for transmitting the initial repetition.

7. (canceled)

8. The method of claim 6, wherein the first resource information, the second resource information or the resource information comprises at least one of a resource block group (RBG) size, a subcarrier spacing (SCS), a bandwidth, or a frequency position of the uplink subband or the uplink BWP, wherein the frequency position is relative to a carrier band in unit of resource block.

9. The method of claim 5, wherein:
the initial repetition is transmitted using the uplink subband in the SBFD symbols; the later repetition is transmitted using the uplink BWP in the non-SBFD symbols; and a first power for transmitting the initial repetition and a second power for transmitting the later repetition are both determined according to a power parameter specified according to the one or more resource control messages for uplink subband transmission, or
the initial repetition is transmitted using the uplink BWP in non-SBFD symbols; the later repetition is transmitted using the uplink subband in SBFD symbols; a first power for transmitting the initial repetition is determined by a first power parameter in the one or more resource control messages for uplink BWP transmission in non-SBFD symbols; and a second power for transmitting the later repetition is determined according to a second power parameter specified in the one or more resource control messages for uplink subband transmission.

10.-12. (canceled)

13. The method of claim 4, wherein determining that the initial repetition and the later repetition of the uplink transmission are allowed to be transmitted in the SBFD symbols and the non-SBFD symbols comprises:
determining a first resource parameter comprising at least one of a first RBG size or a first SCS corresponding to the uplink subband;
determining a second resource parameter comprising at least one of a second RBG size or a second SCS corresponding to the uplink BWP; and
determining that the initial repetition and the later repetition of the uplink transmission are not allowed to be transmitted in SBFD symbols and in non-SBFD symbols when the first resource parameter and the second resource parameter do not match, or are allowed to be transmitted in the SBFD symbols and the non-SBFD symbols when the first resource parameter and the second resource parameter match.

14. The method of claim 4, wherein determining that the initial repetition and the later repetition of the uplink transmission are allowed to be transmitted in the SBFD symbols and the non-SBFD symbols comprises determining that same and/or valid transmission resources can be obtained in the uplink subband and the uplink BWP based on the one or more resource identification fields in the one or more resource control messages in combination with resource information derived from characteristics of the uplink subband and the uplink BWP.

15. The method of claim 4, wherein determining that the initial repetition and the later repetition of the uplink transmission are allowed to be transmitted in the SBFD symbols and the non-SBFD symbols or that the initial repetition and the later repetition of the uplink transmission are allowed to be transmitted either only in SBFD symbols or only in non-SBFD symbols is based on:
a presence/absence of an information field in the one or more resource control messages for indicating that the initial repetition and the later repetition are allowed to be transmitted in the SBFD symbols and non-SBFD symbols; and/or
content of the information field as extracted from the one or more resource control messages.

16. The method of claim 15, wherein:
the information field indicates a first state and a second state; the first state corresponds to both the initial repetition and the later repetition being only allowed to be transmitted both in the uplink subband in SBFD symbols; the second state corresponds to both the initial repetition and the later repetition being only allowed to be transmitted in the uplink BWP in non-SBFD symbols; and the absence of the information field indicates that the initial repetition and the later repetition are allowed to be transmitted across the uplink subband in SBFD symbols and the uplink BWP in non-SBFD symbols; or
the information field indicates a first state and a second state; the first state corresponds to both the initial repetition and the later repetition being only allowed to be transmitted in the uplink subband in SBFD symbols; the second state corresponds to the initial repetition and the later repetition being allowed to be transmitted across the uplink subband in SBFD symbols and the uplink BWP in non-SBFD symbols; and the absence of the information field indicates that both the initial repetition and the later repetition are only allowed to be transmitted in the uplink BWP in non-SBFD symbols; or
the information field, when included, indicates that the later repetition uses a same type among the uplink subband in SBFD symbols or the uplink BWP in non-SBFD symbols as the initial repetition; and the absence of the information field indicates that the initial repetition and the later repetition are allowed to be transmitted across the uplink subband in SBFD symbols and the uplink BWP in non-SBFD symbols.

17.-19. (canceled)

20. The method of claim 4, wherein:
the one or more resource control messages comprises a first resource allocation domain and a second resource allocation domain;
the first resource allocation domain is associated with resource allocation within the uplink subband;
the second resource allocation domain is associated with resource allocation within the uplink BWP; and
determining that the initial repetition and the later repetition of the uplink transmission are allowed to be transmitted in the SBFD symbols and the non-SBFD symbols or determining that the initial repetition and the later repetition of the uplink transmission are allowed to be transmitted either only in the SBFD symbols or only in the non-SBFD symbols is based on the first resource allocation domain and the second resource allocation domain.

21. (canceled)

22. (canceled)

23. The method of claim 4, further comprises:
determining a number of resource allocation domains in the one or more resource control messages;
determining that the initial repetition and the later repetition are transmitted only in the uplink subband in SBFD symbols or the uplink BWP in non-SFBD symbols when the number of resource allocation domains is 1; and
determining that the initial repetition and the later repetition of the uplink transmission are allowed to be transmitted across the uplink subband in SBFD symbols and the uplink BWP in non-SBFD symbols when the number of resource allocation domains is more than 1.

24. The method of claim 1, wherein determining that the initial repetition and the later repetition of the uplink transmission are allowed to be transmitted in SBFD symbols and non-SBFD symbols or that the initial repetition and the later repetition of the uplink transmission are allowed to be transmitted either only in SBFD symbols or only in non-SBFD symbols is based on a presence or absence of an RRC signaling for the wireless terminal.

25. The method of claim 24, further comprising:
determining that the initial repetition and the later repetition of the uplink transmission are allowed to be transmitted in SBFD symbols and non-SBFD symbols when the RRC signaling is present; and otherwise determining that the initial repetition and the later repetition are transmitted in only SBFD symbols or in only non-SBFD symbols, the later repetition being transmitted in only one of the SBFD symbols or the non-SBFD symbols whichever are used for transmitting the initial repetition.

26. (canceled)

27. The method of claim 1, wherein identifying the transmission resources for transmitting the initial repetition and the later repetition of the uplink transmission comprises:
transmitting the initial repetition in a first time slot indicated in the one or more resource control messages; and
when it is determined that the initial repetition and the later repetition of the uplink transmission are allowed to be transmitted in SBFD symbols and the non-SBFD symbols, determining a second time slot, from time slots subsequent to the first time slot for transmitting the later repetition, such that the second time slot contains no fewer consecutive SBFD or non-SBFD symbols than symbols for the initial repetition, and starting symbol for the consecutive SBFD or non-SBFD symbols is same as starting symbol for the initial repetition in the first time slot.

28. The method of claim 1, wherein identifying the transmission resources for transmitting the initial repetition and the later repetition of the uplink transmission comprises:
transmitting the initial repetition in a first time slot indicated in the one or more resource control messages; and
when it is determined that the initial repetition and the later repetition of the uplink transmission are allowed to be transmitted using only the SBFD symbols or only the non-SBFD symbols, determining a second time slot for transmitting the later repetition such that:
in response to the initial repetition in SBFD symbols, the second time slot includes the SBFD symbols; and the second time slot contains no fewer consecutive SBFD symbols than symbols for the initial repetition, and starting symbol for the consecutive SBFD symbols is same as starting symbol for the initial repetition in the first time slot; and
in response to the initial repetition in non-SBFD symbols, the second time slot includes the non-SBFD symbols; and the second time slot contains no fewer consecutive non-SBFD symbols than symbols for the initial repetition, and starting symbol for the consecutive non-SBFD symbols is same as starting symbol for the initial repetition in the first time slot.

29. A wireless terminal of, comprising a memory for storing instructions and at least one processor for executing the instructions to
receive one or more resource control messages for an uplink transmission with repetition;
determine that an initial repetition and a later repetition of the uplink transmission are allowed to be transmitted in subband full duplex (SBFD) symbols and non-SBFD symbols or that the initial repetition and the later repetition of the uplink transmission are allowed to be transmitted either only in SBFD symbols or only in non-SBFD symbols; and
identifying transmission resources for transmitting the initial repetition and the later repetition of the uplink transmission based on the determination.

30. (canceled)

31. A method, performed by a wireless network node in communication with a wireless terminal, comprising:
transmitting one or more resource control messages for an uplink transmission to the wireless terminal for the wireless terminal to:
determine that an initial repetition and a later repetition of the uplink transmission are allowed to be transmitted in subband full duplex (SBFD) symbols and non-SBFD symbols or determining that the initial repetition and the later repetition of the uplink transmission are allowed to be transmitted either only in SBFD symbols or only in non-SBFD symbols; and
identify transmission resources for transmitting the initial repetition and the later repetition of the uplink transmission based on the determination.

32.-60. (canceled)
